(19) United States
(12) Patent Application Publication
(10) Pub. No.: US 2009/0111294 A1
(43) Pub. Date: Apr. 30, 2009

(54) BUS BAR TO PRINTED CIRCUIT BOARD INTERFACE FOR ELECTRIC AND HYBRID ELECTRIC VEHICLES

(75) Inventors: ALAN L. BARRY, TORRANCE, CA (US); MARK D. KORICH, CHINO HILLS, CA (US); TIM S. FRAGALE, LONG BEACH, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/924,453

(22) Filed: Oct. 25, 2007

(51) Int. Cl. H01R 12/00; H02H 3/00

(52) U.S. Cl. 439/78; 361/62

(57) ABSTRACT

A bus bar and a related electrical assembly for an electric traction system of a vehicle are provided. The bus bar includes an electrically conductive body configured for coupling to an electrical device high current node, the electrically conductive body comprising a circuit board mounting end, and a plurality of electrically conductive fingers extending from the circuit board mounting end. The fingers are configured to accommodate soldering to at least one conductive trace of a circuit board.

### TECHNICAL FIELD

The subject matter described herein generally relates to electronic systems, and more particularly relates to a bus bar suitable for use with electric and hybrid electric vehicles.

### BACKGROUND

Hybrid electric, fully electric, fuel cell, and other fuel efficient vehicles are becoming increasingly popular. Electric and hybrid electric vehicles utilize high voltage battery packs or fuel cells that deliver high DC current necessary to drive the electric traction systems. These vehicles use thick electrical conductors known as bus bars to deliver the high operating current from the battery packs to the necessary onboard electrical systems. Bus bars are utilized because the high current usually exceeds the rating of ordinary wires or cables. In practice, a bus bar can be fabricated from a solid stock of conductive metal or from a thick sheet of conductive metal.

In some applications it may be necessary to mount a bus bar to a printed circuit board having electrically conductive traces formed thereon. Historically, a mechanical assembly approach has been taken with respect to the design of bus bars. In this regard, a bus bar is usually coupled to a printed circuit board using fasteners such as bolts, where torque applied to the fasteners results in the bus bar establishing physical and electrical contact with a conductive trace on the printed circuit board.

### BRIEF SUMMARY

An embodiment of a bus bar for an electric traction system of a vehicle is provided. The bus bar includes an electrically conductive body configured for coupling to an electrical device high current node, where the electrically conductive body comprises a circuit board mounting end, and a plurality of electrically conductive fingers extending from the circuit board mounting end of the electrically conductive body. The electrically conductive fingers are configured to accommodate through-hole soldering to at least one conductive trace of a circuit board.

An alternate embodiment of a bus bar for an electric traction system of a vehicle is also provided. This embodiment of the bus bar includes an electrically conductive body configured for coupling to an electrical device high current node, the electrically conductive body comprising a circuit board mounting end, and a plurality of electrically conductive fingers extending from the circuit board mounting end of the electrically conductive body. The electrically conductive fingers are configured to accommodate surface mounting to at least one conductive trace of a circuit board.

An embodiment of an electrical assembly for an electric traction system of a vehicle is also provided. The electrical assembly includes a circuit board comprising a conductive trace formed thereon, and a bus bar comprising a circuit board mounting end and a plurality of electrically conductive fingers extending from the circuit board mounting end. The electrically conductive fingers are soldered to the conductive trace.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWINGS

At least one embodiment of the present invention will hereinafter be described in conjunction with the following drawing figures, wherein like numerals denote like elements, and

FIG. 1 is a perspective view of an embodiment of a bus bar that is configured for through-hole soldering to a circuit board;

FIG. 2 is a top perspective view of the bus bar shown in FIG. 1 mounted to a circuit board;

FIG. 3 is a bottom perspective view of the circuit board shown in FIG. 2, before soldering;

FIG. 4 is a bottom perspective view of the circuit board shown in FIG. 2, after soldering;

FIG. 5 is a perspective view of an embodiment of a bus bar that is configured for surface mounting to a circuit board;

FIG. 6 is a top perspective view of an embodiment of a circuit board configured to accommodate surface mounting of the bus bar shown in FIG. 5; and

FIG. 7 is a top perspective view of the bus bar shown in FIG. 5 after surface mounting to the circuit board shown in FIG. 6.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

For the sake of brevity, conventional techniques related to electrical power device operation, electric traction systems for vehicles, electrical system fabrication, circuit board fabrication, and other functional aspects of the systems (and the individual operating components of the systems) may not be described in detail herein. Furthermore, the figures contained herein are intended to represent example functional relationships and/or physical couplings between various elements. It should be noted that many alternative or additional functional relationships or physical connections may be present in a practical embodiment.

As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common mode).

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

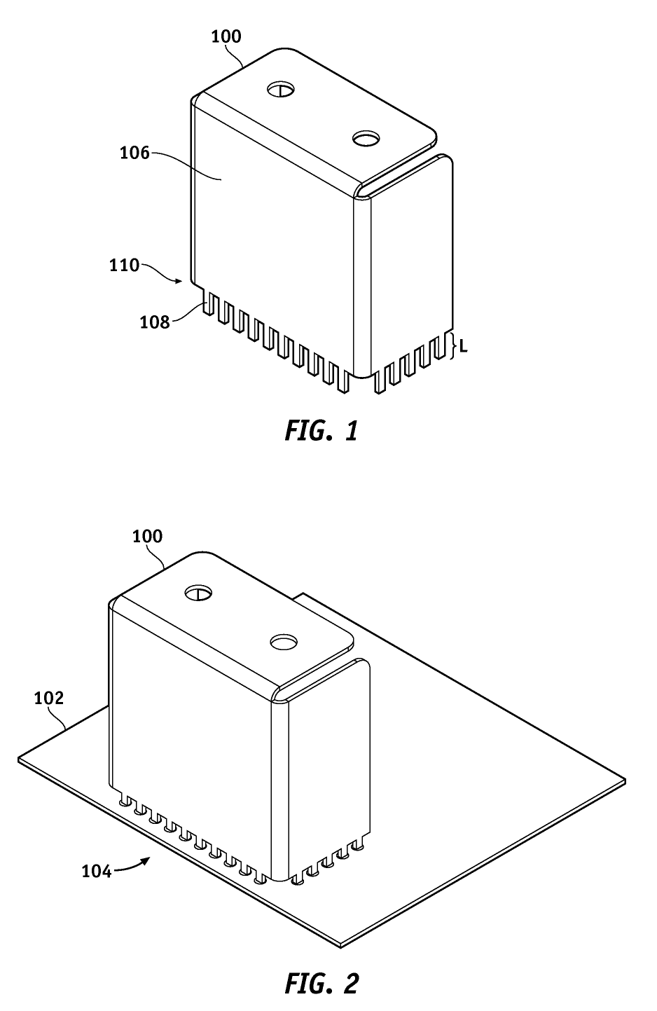

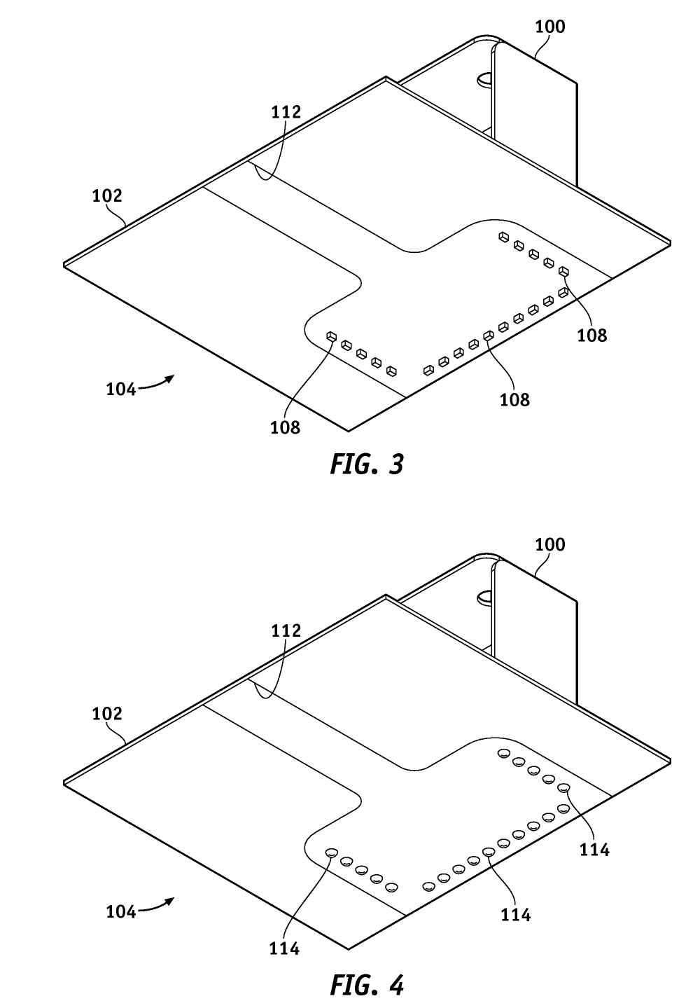

FIG. 1 is a perspective view of an embodiment of a bus bar 100 that is configured for through-hole soldering to a circuit board, FIG. 2 is a top perspective view of bus bar 100 mounted to a circuit board 102, FIG. 3 is a bottom perspective view of circuit board 102 before soldering of bus bar 100 thereto, and FIG. 4 is a bottom perspective view of circuit board 102 after soldering of bus bar 100 thereto. The combination of bus bar 100 and circuit board 102 form an electrical assembly 104 that can be suitably configured and arranged for use with an electric traction system of a vehicle (e.g., a pure electric vehicle or a hybrid electric vehicle). For ease of illustration and description of the subject matter, FIGS. 1-4 depict a simple and compact electrical assembly 104. In practice, an embodiment of electrical assembly 104 may be more complex and larger than that shown, circuit board 102 may include additional components coupled thereto, and bus bar 100 may be shaped and arranged differently than that shown. When deployed with an electric traction system of a vehicle, electrical assembly 104 may be utilized in a DC-to-DC converter, a power inverter module, a DC power bus that delivers high DC current from a battery or fuel cell subsystem of the vehicle, a high current interconnect, or the like.

This embodiment of bus bar 100 includes an electrically conductive body 106 and a plurality of electrically conductive fingers 108 coupled to body 106. Body 106 is configured for coupling to an electrical device high current node, i.e., an electrical node through which a relatively high current flows during operation. This high current node may be associated with a battery pack terminal, a cable connector, an output node of a power amplifier, or the like. In certain non-limiting embodiments, bus bar 100 can handle currents up to 200 amps.

Body 106 has a circuit board mounting end 110, and fingers 108 extend from circuit board mounting end 110. Fingers 108 are suitably sized, shaped, and configured to accommodate through-hole soldering to at least one conductive trace 112 of circuit board 102 (see FIG. 3 and FIG. 4). The fingers extend straight down and are perpendicular to the surface of the board. For this non-limiting example, each finger 108 has a length of about three millimeters and a width of about one millimeter. As used here, through-hole soldering refers to any circuit board soldering technique where the circuit board includes holes that receive fingers, pins, or prongs of a component to be soldered, and where the fingers, pins, or prongs are soldered in place (typically from the bottom side of the circuit board) to establish physical and electrical connections between the circuit board and the component.

In the illustrated embodiment, bus bar 100 is fabricated as a one-piece component from a metal sheet. Thus, body 106 and fingers 108 may be integrally formed by stamping, machining, drilling, bending, and otherwise processing a suitable metal sheet. In certain non-limiting embodiments, bus bar 100 is stamped from a copper or aluminum sheet having a nominal thickness within the range of about 0.025 inch to about 0.200 inch. In alternate embodiments, bus bar 100 (including body 106 and fingers 108) is formed from a solid stock of conductive metal.

Although not required in all implementations, fingers 108 are preferably integrated with body 106. This integration ensures that fingers 108 are electrically coupled to body 106 with little or no electrical resistance between fingers 108 and body 106. To facilitate soldering, bus bar 100 includes solder-compatible plating material (such as tin) on fingers 108. This plating material is used to ensure that structurally and electrically sound solder connections are formed between fingers 108 and trace 112. Moreover, fingers 108 are configured to reduce heat transfer into body 106 (this ensures that body 106 does not act as a heat sink during soldering). In this regard, fingers 108 are relatively narrow and spaced apart in a manner that creates relatively high thermal resistance between the tips of fingers 108 and body 106. For this particular embodiment, fingers 108 and the plating material are suitably configured to accommodate a wave solder process. Wave soldering equipment and related soldering processes are commonly used in the manufacture of electrical circuit boards and, therefore, such equipment and processes will not be described in detail here.

Circuit board 102 can be manufactured in accordance with well known printed circuit board techniques and technologies. For example, circuit board 102 may include a fiberglass substrate board having formed thereon conductive trace 112, other conductive traces, features, and components (not shown).

Electrical assembly 104 can be fabricated in the following manner, assuming that a suitably configured bus bar 100 and a compatible circuit board 102 have already been manufactured. Notably, circuit board 102 will include a plated through hole pattern that matches the layout of fingers 108. Moreover, for this embodiment each of the fingers 108 will have a length that exceeds the thickness of circuit board 102. This specified length is desirable to accommodate soldering of fingers from the bottom of circuit board 102. FIG. 1 includes the label “L” to indicate the length of fingers 108.

During manufacturing, bus bar 100 is placed onto circuit board such that fingers 108 extend into the through holes (see FIG. 2 and FIG. 3). Thereafter, fingers 108 are soldered to conductive trace 112 using an appropriate soldering technique. In practice, bus bar 100 and other components of electrical assembly 104 (e.g., connectors, capacitors, transformers, transistors, or the like) can be soldered to circuit board 102 during the same soldering process, thus reducing manufacturing time and labor cost. FIG. 4 depicts electrical assembly 104 after soldering has formed solder fillets 114 on fingers 108. For this embodiment, a single conductive trace 112 located on the bottom of circuit board 102 is used for all fingers 108. Alternate embodiments may employ multiple conductive traces located on the top and/or bottom of circuit board 102.

In preferred embodiments, fingers 108 represent the only means for attaching bus bar 100 to circuit board 102. Thus, in contrast to conventional bus bar mounting techniques, electrical assembly 104 need not utilize screws, bolts, clips, or brackets to establish the physical and electrical connections. Historically, bus bars utilized in electric traction systems have been designed from a mechanical engineering approach, wherein mechanical coupling techniques are employed for the physical and electrical connection. Unfortunately, the use of securing bolts requires physical clearance to accommodate wrenches or other assembly tools. In addition, the use of securing bolts or fasteners results in torque applied to the circuit board during assembly, and the resulting stress may cause structural damage and/or electrical discontinuities. The solution described herein eliminates the need for torque-producing tools (e.g., wrenches or screwdrivers), enhances the electrical integrity of the connection between the bus bar and the circuit board, and reduces assembly time and parts count.

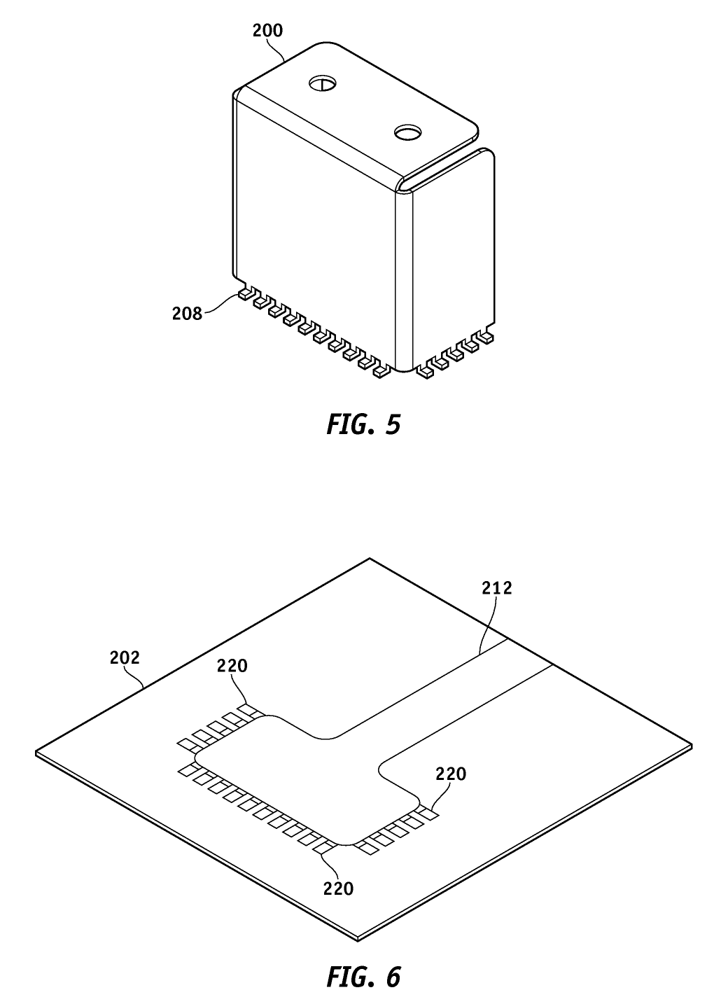

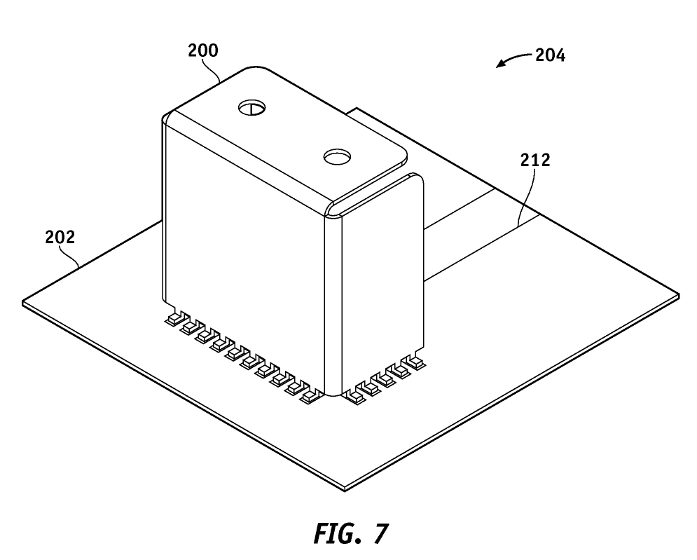

FIG. 5 is a perspective view of an embodiment of a bus bar 200 that is configured for surface mounting to a circuit board, FIG. 6 is a top perspective view of an embodiment of a circuit board 202 configured to accommodate surface mounting of bus bar 200, and FIG. 7 is a top perspective view of bus bar 200 after surface mounting to circuit board 202. Bus bar 200 is similar to bus bar 100 in many respects. For the sake of brevity, common features, characteristics, and qualities that are shared by bus bar 100 and bus bar 200 will not be redundantly described here in the context of bus bar 200.

The combination of bus bar 200 and circuit board 202 form an electrical assembly 204 that can be suitably configured and arranged for use with an electric traction system of a vehicle as described above. This embodiment of bus bar 200 includes fingers 208 that are suitably sized, shaped, and configured to accommodate surface mounting to at least one conductive trace 212 of circuit board 202 (see FIG. 6). As used here, surface mounting refers to any circuit board soldering technique where the circuit board includes conductive pads that accommodate corresponding fingers, pins, or prongs of a component to be mounted, and where the fingers, pins, or prongs are flow soldered onto the conductive pads to establish physical and electrical connections between the circuit board and the component.

Although not required in all implementations, fingers 208 are preferably integrated with the body of bus bar 200. As depicted in FIG. 5, each of the fingers 208 is substantially L-shaped, forming surface-mounting feet. The base of the feet are parallel to the board surface and are intended for flush mounting. To facilitate surface mounting, bus bar 200 includes solder-compatible plating material (such as tin) on fingers 208. For this particular embodiment, fingers 208 and the plating material are suitably configured to accommodate a surface mounting process. Surface mounting equipment and related surface mounting processes are commonly used in the manufacture of electrical circuit boards and, therefore, such equipment and processes will not be described in detail here.

Electrical assembly 204 can be fabricated in the following manner, assuming that a suitably configured bus bar 200 and a compatible circuit board 202 have already been manufactured. Notably, circuit board 202 will include a pattern of contact pads 220 that matches the layout of fingers 208. For the illustrated embodiment, each of the contact pads 220 is electrically connected to conductive trace 212. In other words, contact pads 220 and conductive trace 212 correspond to a common electrical node.

During manufacturing, an appropriate solder paste is selectively applied to specified areas of circuit board 202, including contact pads 220. Thereafter, bus bar 200 is placed onto circuit board 202 such that fingers 208 are aligned with the respective contact pads 220. In practice, bus bar 200 may include alignment or indexing features (e.g., pins) that mate with corresponding features of circuit board 202 such that bus bar 200 remains stationary during the surface mounting process. Thereafter, fingers 208 are soldered to contact pads 220 using an appropriate surface mounting technique. During the surface mounting process, electrical assembly 204 is heated such that the solder paste reflows under and around fingers 208. In practice, bus bar 200 and other components of electrical assembly 204 (e.g., connectors, capacitors, transformers, transistors, or the like) can be attached to circuit board 202 during the same surface mounting process, thus reducing manufacturing time and labor cost. FIG. 7 depicts electrical assembly 104 after completion of the surface mounting process. As mentioned above in the context of bus bar 100, fingers 208 represent the only means for attaching bus bar 200 to circuit board 202.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A bus bar for an electric traction system of a vehicle, the bus bar comprising:
an electrically conductive body configured for coupling to an electrical device high current node, the electrically conductive body comprising a circuit board mounting end; and
a plurality of electrically conductive fingers extending from the circuit board mounting end of the electrically conductive body, the electrically conductive fingers being configured to accommodate through-hole soldering to at least one conductive trace of a circuit board.

2. The bus bar of claim 1, the electrically conductive fingers being integrated with the electrically conductive body.

3. The bus bar of claim 2, the electrically conductive body and the electrically conductive fingers being integrally formed from a metal sheet.

4. The bus bar of claim 1, further comprising solder-compatible plating material on the electrically conductive fingers.

5. The bus bar of claim 4, wherein the electrically conductive fingers and the solder-compatible plating material are configured to accommodate a wave solder process.

6. The bus bar of claim 1, wherein the electrically conductive fingers represent the only means for attaching the bus bar to the circuit board.

7. The bus bar of claim 1, wherein each of the electrically conductive fingers has a length that exceeds the thickness of the circuit board.

8. A bus bar for an electric traction system of a vehicle, the bus bar comprising:
an electrically conductive body configured for coupling to an electrical device high current node, the electrically conductive body comprising a circuit board mounting end; and
a plurality of electrically conductive fingers extending from the circuit board mounting end of the electrically conductive body, the electrically conductive fingers being configured to accommodate surface mounting to at least one conductive trace of a circuit board.

9. The bus bar of claim 8, the electrically conductive fingers being integrated with the electrically conductive body.

10. The bus bar of claim 9, the electrically conductive body and the electrically conductive fingers being integrally formed from a metal sheet.

11. The bus bar of claim 8, further comprising solder-compatible plating material on the electrically conductive fingers.

12. The bus bar of claim 8, wherein the electrically conductive fingers represent the only means for attaching the bus bar to the circuit board.

13. The bus bar of claim 8, each of the electrically conductive fingers being substantially L-shaped.

14. An electrical assembly for an electric traction system of a vehicle, the electrical assembly comprising:
a circuit board comprising a conductive trace formed thereon; and
a bus bar comprising a circuit board mounting end and a plurality of electrically conductive fingers extending from the circuit board mounting end, the electrically conductive fingers being soldered to the conductive trace.

15. The electrical assembly of claim 14, the electrically conductive fingers being configured to accommodate through-hole soldering to the conductive trace.

16. The electrical assembly of claim 14, the electrically conductive fingers being configured to accommodate surface mounting to the conductive trace.

17. The electrical assembly of claim 14, further comprising solder-compatible plating material on the electrically conductive fingers.

18. The electrical assembly of claim 14, wherein the electrically conductive fingers represent the only means for attaching the bus bar to the circuit board.

19. The electrical assembly of claim 14, the bus bar being configured to deliver high DC current from a battery subsystem of the vehicle.

20. The electrical assembly of claim 14, the circuit board comprising a fiberglass substrate printed circuit board.
